(19) United States
(12) Patent Application Publication
(10) Pub. No.: US 2025/0246091 A1
(43) Pub. Date: Jul. 31, 2025

(54) Math and Business Concepts Learning System Using Virtual Construction and Market Simulation

(71) Applicants: Gabrielle Joyce, Pittsburgh, PA (US); Patricia Lee, Pittsburgh, PA (US)

(72) Inventors: Gabrielle Joyce, Pittsburgh, PA (US); Patricia Lee, Pittsburgh, PA (US)

(21) Appl. No.: 18/983,563

(22) Filed: Dec. 17, 2024

Related U.S. Application Data
(60) Provisional application No. 63/626,194, filed on Jan. 29, 2024.

(51) Int. Cl. G09B 9/00; G06Q 50/20; G09B 19/18; G09B 25/04

(52) U.S. Cl. CPC G09B 9/00; G06Q 50/205; G09B 19/18; G09B 25/04

(57) ABSTRACT

An interactive educational system designed to teach children fundamental math and business concepts through engaging gameplay is disclosed. The system includes a mobile application and a web application, both integrated with a server system that manages user registration, profile customization, and authentication. The system offers a variety of building projects that require users to apply mathematical principles such as area, perimeter, addition, subtraction, and multiplication. Users manage in-game currency to purchase materials and decorations and can sell completed virtual structures in an in-app marketplace, with profit or loss automatically calculated. The system further includes features for teacher interaction, feedback, and collaborative projects for a comprehensive and adaptive learning environment for users.

### CROSS-REFERENCE TO RELATED APPLICATION

The present application claims priority to, and the benefit of, U.S. Provisional Application No. 63/626,194, which was filed on Jan. 29, 2024, and is incorporated herein by reference in its entirety.

### FIELD OF THE INVENTION

The present invention generally relates to the field of educational technology and interactive learning systems. More specifically, the present invention relates to an educational system designed to teach math and business concepts through engaging, game-based simulations. The system includes a mobile application and a web application that interact with a server system housing modules for user management, game logic, and financial calculations. The system allows users to create personalized avatars, engage in building projects that integrate real-world entrepreneurial scenarios, and manage in-game currency for purchasing materials. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, mathematical and business skills along with entrepreneurial skills are essential for success in both personal and professional life. However, despite their importance, these skills are often not taught effectively within traditional educational environments. The conventional methods of teaching these concepts, especially to younger students, often fails to capture their interest. Conventional methods of instruction may not engage students, leading to a lack of motivation and interest in the subject matter.

In many cases, students find it hard to connect the abstract principles of mathematics and business with real-world applications. This disconnection can result in students perceiving these subjects as irrelevant or unimportant, further diminishing their engagement. Moreover, traditional classroom settings typically do not provide students with hands-on experiences that are crucial for understanding and applying entrepreneurial concepts.

As a result, students may graduate with insufficient exposure to practical business skills, such as budgeting, profit and loss analysis, and investment strategies. The lack of entrepreneurial education in schools' leaves students unprepared for real-world challenges, limiting their ability to think critically, solve problems, and make informed decisions. People desire an innovative educational approach that does not teach math and business concepts effectively in an engaging way.

Therefore, there exists a long-felt need in the art for a system that can effectively teach children essential math and business concepts in a manner that is both engaging and interactive. There is also a long-felt need in the art for a solution that integrates real-world experiences, such as entrepreneurial activities and financial management. Additionally, there is a long-felt need in the art for a system that can cater to individual learning styles. Moreover, there is a long-felt need in the art for an educational platform that facilitates collaboration between students, teachers, and parents, ensuring that learning is a comprehensive and supportive experience. Furthermore, there is a long-felt need in the art for a user-friendly educational tool that bridges the gap between theoretical knowledge and practical application. Finally, there is a long-felt need in the art for an innovative approach to education that keeps students interested in learning while improving their math and business skills.

The subject matter disclosed and claimed herein, in one embodiment thereof, comprises an interactive educational system designed to teach math and business concepts through simulated building projects and real-world scenarios. The system includes a mobile application and a web application, both of which interface with a server system that provides essential services such as user management, game logic, and financial calculations. The mobile and web applications allow users to create personalized avatars, engage in a variety of building activities, and manage in-game currency to purchase materials and decorations. The system includes a marketplace where users can sell completed virtual structures, providing a simulated environment for practicing entrepreneurial skills and understanding profit and loss. Teachers and parents can monitor student progress and provide feedback through integrated collaboration tools, enhancing the overall learning experience.

In this manner, the interactive educational system of the present invention accomplishes all of the foregoing objectives and provides a comprehensive solution for teaching children math and business skills in an engaging and practical way. The system integrates real-world scenarios into the learning process and helps students develop critical thinking and problem-solving skills. The system offers a simulated marketplace which offers a hands-on approach to understanding financial principles, such as budgeting and profit calculation, which are often difficult to grasp through traditional methods.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for teaching math and business concepts through interactive gameplay. The system comprises a mobile application executed on a mobile device, wherein the mobile application is configured to enable a user to interact with the system, a web application executed on a web browser, wherein the web application provides the same functionality and interfaces as the mobile application, a server system is in communication with the mobile application and the web application over a communication network, the server system comprises a user management module configured to handle user registration, profile management, and authentication, and to recommend personalized learning games to users based on stored user profiles, a game logic service configured to manage building projects, game rules, and task progression of users during gameplay, wherein the game logic service employs artificial intelligence to customize games based on user profiles, a calculation service configured to process in-game transactions, mathematical calculations, budgeting, and profit/loss calculations, and an avatar generator module configured to enable users to create and customize personalized avatars to be used in the system.

In yet another embodiment, a method for teaching math and business concepts through a simulated building environment is disclosed. The method includes the steps of registering a user in a system through a mobile or web application, creating a personalized avatar for the user via an avatar generator module, providing the user with a plurality of building projects through a game logic service, wherein the building projects require the user to solve mathematical problems related to area, perimeter, measurement, addition, subtraction, and multiplication, processing in-game transactions using a calculation service, wherein the user manages a virtual currency to purchase materials and decorations for the building projects, enabling the user to sell completed virtual structures on a marketplace provided by the system, and calculating profit or loss based on the construction costs and sale price of the structures.

In another embodiment, a non-transitory computer-readable medium having instructions stored thereon, the instructions, when executed by a processor, causing the processor to perform a method for teaching math and business concepts is disclosed. The method comprises providing a user with access to a mobile or web application for interacting with a system, enabling the user to create a personalized avatar using an avatar generator module, delivering a plurality of building projects to the user through a game logic service, wherein the projects involve solving mathematical problems, including area, perimeter, measurement, addition, subtraction, and multiplication, managing in-game currency transactions through a calculation service, allowing the user to budget and purchase materials and decorations for the building projects, facilitating the sale of completed structures on a marketplace, where the profit or loss is calculated based on construction costs and sale price, and storing user performance data and providing personalized feedback and recommendations based on the data.

In still another embodiment, a method implemented in an educational system for teaching children math and business concepts is described. The method comprises the steps of creating a user account and personalized avatar through a mobile or web application, assigning the user to a plurality of building activities designed to develop entrepreneurial skills, wherein each activity includes mathematical problems related to area, perimeter, measurement, addition, subtraction, and multiplication, enabling the user to manage a virtual currency to purchase construction materials and decorations, with transactions processed by a server-based calculation service, and allowing the user to sell completed virtual structures in an in-app marketplace, with automatic calculation of profit or loss based on the costs and sale price.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates the overall architecture of math and business concepts teaching game system of the present invention in accordance with the disclosed architecture;

FIG. 2 illustrates an exemplary user interface displayed by the mobile application for initiating interaction with the system in accordance with the disclosed architecture;

FIG. 3 illustrates an exemplary user interface for displaying personal information of a user in accordance with one embodiment of the present invention;

FIG. 4 illustrates another exemplary interface displayed by the mobile application of the present invention for displaying user profile and building information in accordance with one embodiment of the present invention;

FIG. 5 illustrates a user interface for constructing a building and calculating cost of materials for imparting mathematical training to users in accordance with the disclosed structure;

FIG. 6 illustrates a marketplace offered by the math and business concepts teaching game system of the present invention in accordance with the disclosed structure;

FIG. 7 illustrates an exemplary interface displayed by the application when a built structure is sold on the marketplace in accordance with one embodiment of the present invention;

FIG. 8 illustrates a flow chart depicting a process of onboarding a student in the system using the application in accordance with the disclosed architecture;

FIG. 9 illustrates a flow chart depicting a process of collaboration between the students and a teacher for reviewing performance of the students using the application in accordance with the disclosed architecture;

FIG. 10 illustrates another flow chart depicting a process of making structures by students while using money management and mathematical skills in accordance with one embodiment of the present invention; and

FIG. 11 illustrates a perspective view showing a teacher reviewing performance of different students based on the activities performed using the application in accordance with the disclosed architecture

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that can effectively teach children essential math and business concepts in a manner that is both engaging and interactive. There is also a long-felt need in the art for a solution that integrates real-world experiences, such as entrepreneurial activities and financial management. Additionally, there is a long-felt need in the art for a system that can cater to individual learning styles. Moreover, there is a long-felt need in the art for an educational platform that facilitates collaboration between students, teachers, and parents, ensuring that learning is a comprehensive and supportive experience. Furthermore, there is a long-felt need in the art for a user-friendly educational tool that bridges the gap between theoretical knowledge and practical application. Finally, there is a long-felt need in the art for an innovative approach to education that keeps students interested in learning while improving their math and business skills.

The present invention, in one exemplary embodiment, is a non-transitory computer-readable medium having instructions stored thereon, the instructions, when executed by a processor, causing the processor to perform a method for teaching math and business concepts. The method comprises providing a user with access to a mobile or web application for interacting with a system, enabling the user to create a personalized avatar using an avatar generator module, delivering a plurality of building projects to the user through a game logic service, wherein the projects involve solving mathematical problems, including area, perimeter, measurement, addition, subtraction, and multiplication, managing in-game currency transactions through a calculation service, allowing the user to budget and purchase materials and decorations for the building projects, facilitating the sale of completed structures on a marketplace, where the profit or loss is calculated based on construction costs and sale price, and storing user performance data and providing personalized feedback and recommendations based on the data.

Reference will now be made in detail to the present preferred embodiments of the invention, examples of which are illustrated in the accompanying drawings. Wherever possible, the same reference numerals are used in the drawings and the description to refer to the same or like parts.

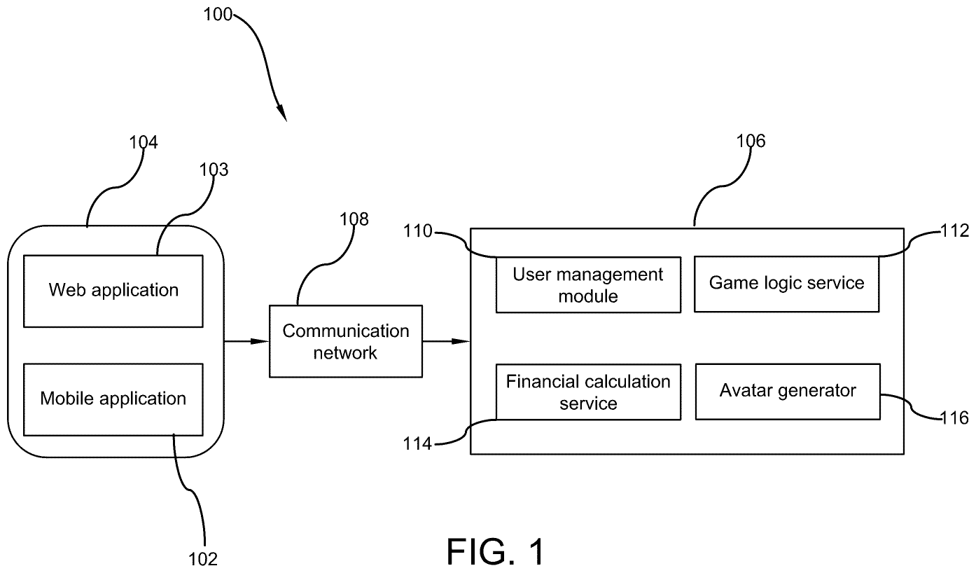

Referring initially to the drawings, FIG. 1 illustrates the overall architecture of math and business concepts teaching game system of the present invention in accordance with the disclosed architecture. The math and business concepts teaching system 100 of the present invention is designed as an innovative educational application system designed to teach children fundamental math and business concepts through interactive and engaging gameplay. The system 100 combines elements of simulation, problem-solving, and creative design to provide a comprehensive learning experience. More specifically, the system 100 has a client-server architecture and includes a mobile application 102 and a web application 103. The applications 102,103 are configured to enable users to interact with the system on a mobile device 104 such as but not limited to a smartphone. The web application 103 allows the access via web browsers and is designed to provide the same functionality and interfaces as offered by the mobile application 102.

A server system 106 is included in the system 100 and may use frameworks such as but not limited to Node.js (Express), Django (Python), or Spring Boot (Java). The server system 106 can use RESTful APIs to facilitate communication between the applications 102,103 and the services offered by the server system 106. The applications 102,103 and the server system 106 are adapted to communicate using a communication network 108 which is preferably but not limited to a private network. The server system 106 includes a user management module 110 which is configured to handle user registration, user profile management, and authentication of a user to the system 100. The user management module 110 is also used for recommending personalized learning games to users based on their stored profiles. The user management module 110 is preferably in the form of a relational database but can be in the form of any storage module.

The system 100 provides a plurality of building activities which allow engages students in real world experiences such as but not limited to investing and real estate trading to build entrepreneurial experience. A game logic service 112 is configured to provide a plurality of building projects, manage the game rules, and manage task progression of the users during the project's execution. The game logic service 112 may use artificial intelligence for building customized games based on profiles of the users. It will be noted that the in the system 100 of the present invention, students can work on mathematical skills like area, perimeter, adding, subtracting, multiplying, measurement, and more during a simulated construction of a building using raw materials. A calculation service 114 processes in-game transactions, mathematical calculations, budgeting, and profit/loss calculations. An avatar generator module 116 enables users to create their personalized avatars to be used as their representation in the system 100 and during games.

In some embodiments of the present invention, an educational institute such as a school or a teacher can enroll a student in the system 100 and may provide the access to the system 100. Further, activities of the enrolled students can be reviewed by teachers and/or parents.

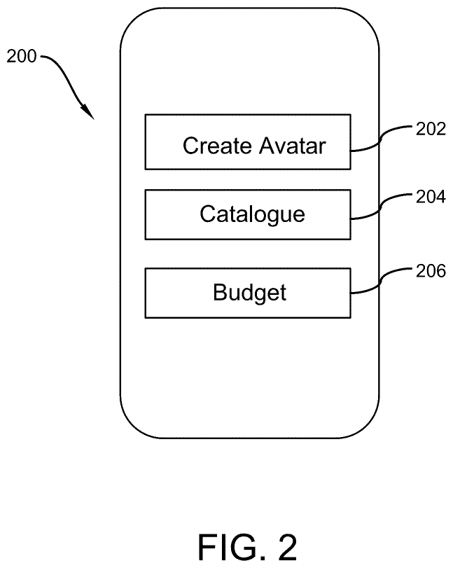

FIG. 2 illustrates an exemplary user interface displayed by the mobile application 102 for initiating interaction with the system 100 in accordance with the disclosed architecture. The mobile application 102 is comprised of a home page 200 that is the first user interface displayed to a new user and provides a Create Avatar option 202. The option 202 allows the application 102 to access the camera of the mobile device 104 for capturing an image or video of the user to create an avatar. The catalogue option 204 enables the users to customize their avatar by displaying a variety of options such as skin tone, hairstyle, face style, and more. A budget option 206 displays the available in-game currency for the user that can be used for purchasing customization items. The available in-game currency can be a pre-determined virtual currency and can be used for purchasing raw items for buildings and can be earned by selling virtual buildings created by the users on a marketplace offered by the system 100.

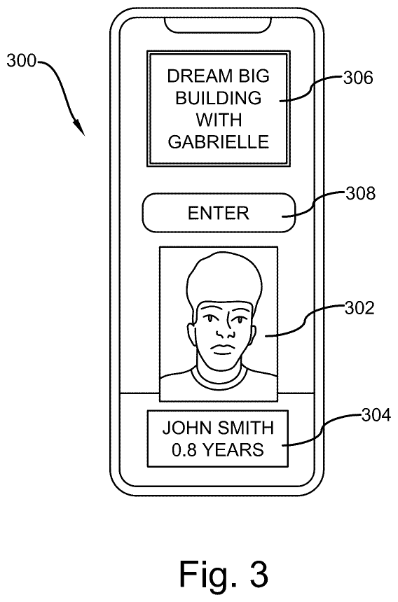

FIG. 3 illustrates an exemplary user interface for displaying personal information of a user in accordance with one embodiment of the present invention. The user interface 300 is displayed once the user is authenticated by the application 102 and displays the avatar 302 of the user. The avatar 302 can be customized by the user based on the personal preference thereof, as noted above. The interface 300 also displays additional information 304 such as the name and tenure of the user in the system 100. The application 102 is adapted to display a logo or indicia 306 representing the system 100 and the application 102 on different user interfaces for marketing and branding purposes. The Enter button 308, when pressed allows the user to enter the game zone where the user can play building games and access a marketplace 600 offered by the math and business concepts learning system using virtual construction and market simulation.

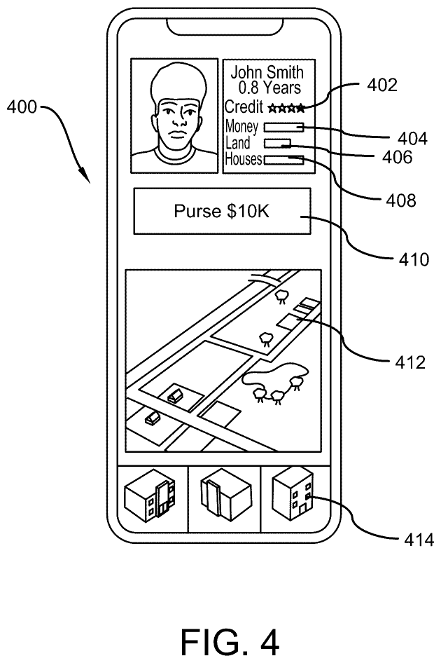

FIG. 4 illustrates another exemplary interface displayed by the mobile application 102 of the present invention for displaying user profile and building information in accordance with one embodiment of the present invention. The interface 400 displays an overall credit rating 402 of the user wherein the credit rating is based on available balance, transaction history, number of sales and purchases made by the user within the system 100. Bar representations 404,406,408 for money, land, and houses respectively are displayed to indicate the remaining quantity of the assets of the user.

The current in-game currency balance 410 of the user is displayed and is adjusted in real-time based on transactions performed by the user. The in-game currency 410 can be customized to be in different currencies based on location of the user such as in different continents or countries. A current building 412 being made the user is displayed as the main window and the user can make modifications in real-time by adding or removing furniture, land, and more. The interface 400 is also adapted to display different buildings 414 made by the user wherein the buildings can be sold using the marketplace 600 offered by the math and business concepts learning system using virtual construction and market simulation 100.

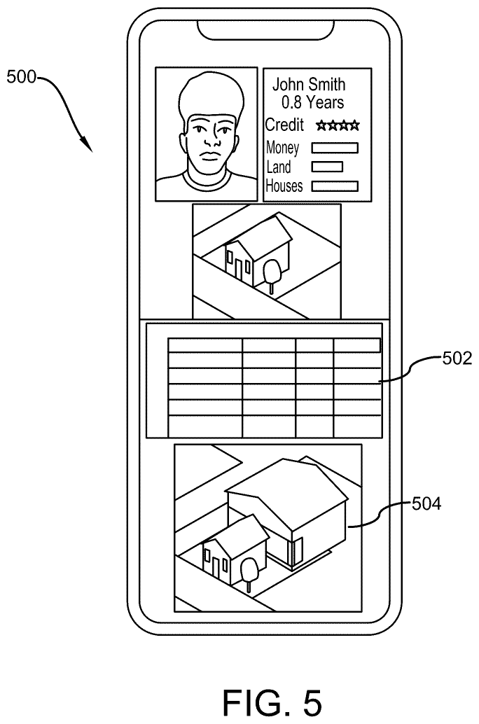

FIG. 5 illustrates a user interface for constructing a building and calculating cost of materials for imparting mathematical training to users in accordance with the disclosed structure. The system 100 and the application 102 provides a project workspace where users can apply mathematical concepts to design and build structures. As illustrated, a real-time calculation table 502 is displayed by the interface 500 which includes calculation of cost of different raw materials or furniture used in building a structure 504. The table 502 allows users to perform and verify mathematical operations such as addition, subtraction, multiplication, and more. The cost of the structure is deducted from the in-game currency balance 410 of the user in real-time and when a structure is sold by the user, the transacted amount is added to the balance 410 of the user.

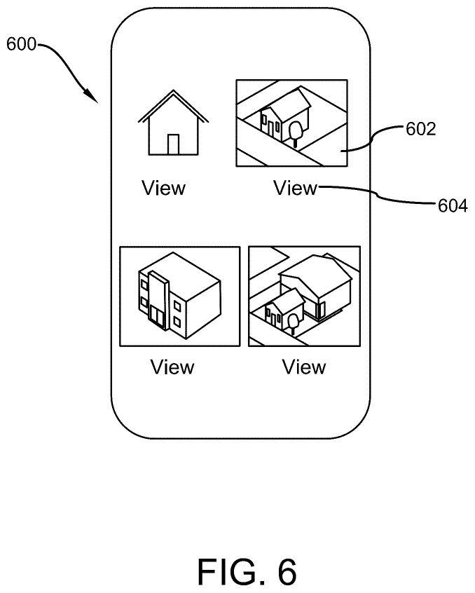

FIG. 6 illustrates a marketplace offered by the math and business concepts teaching game system of the present invention in accordance with the disclosed structure. The marketplace 600 can be used by users of the system for performing transactions of the built structures. The marketplace 600 can display customized and recommended structures to different users based on their profiles. As illustrated, a plurality of structures 602 available to be sold are listed on the marketplace 600 and additional information such as cost, seller, materials used, and more can be viewed by clicking the View button 604. The marketplace 600 provides a simulated market environment and guides users through calculating profits or losses based on construction costs and sale price, introducing basic economic principles.

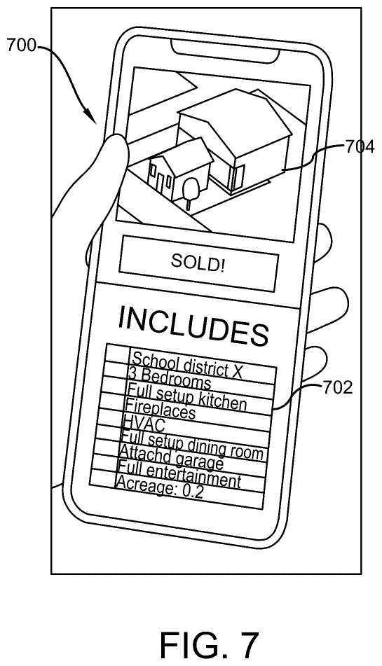

FIG. 7 illustrates an exemplary interface displayed by the application when a built structure is sold on the marketplace 600 in accordance with one embodiment of the present invention. When a structure is sold by a user (seller) and purchased by another user (purchaser), the in-game currency is automatically added to the seller's profile and is deducted from the buyer's profile. When a structure is sold, a notification is sent to both the seller and the buyer. As illustrated, the interface 700 displays the items 702 included in the sold structure 704, thereby allowing the buyer to verify the items with 360-degree view of the structure provided by the interactive educational system for teaching math and business concepts 100.

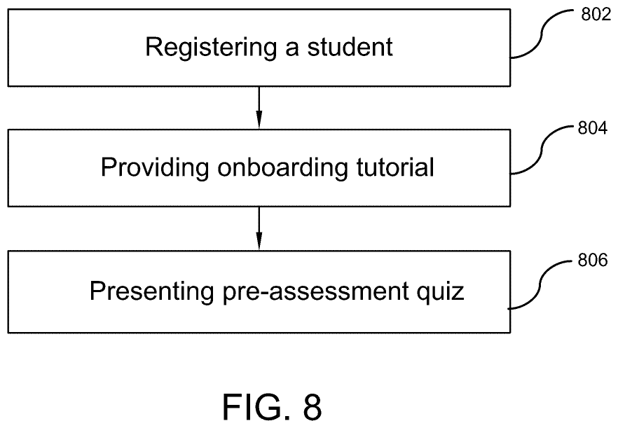

FIG. 8 illustrates a flow chart depicting a process of onboarding a student in the system 100 using the application 102 in accordance with the disclosed architecture. Initially, a student is registered in the system by signing up and creating an avatar (Step 802). Then, an onboarding tutorial is presented to the student for learning different features such as mathematical operations, building structures and more using the system (Step 804). Thereafter, a pre-assessment quiz is presented to the student, wherein based on the result of the quiz, different building structures activities are provided to the student and the result may also be provided to the teacher and parents of the student (Step 806).

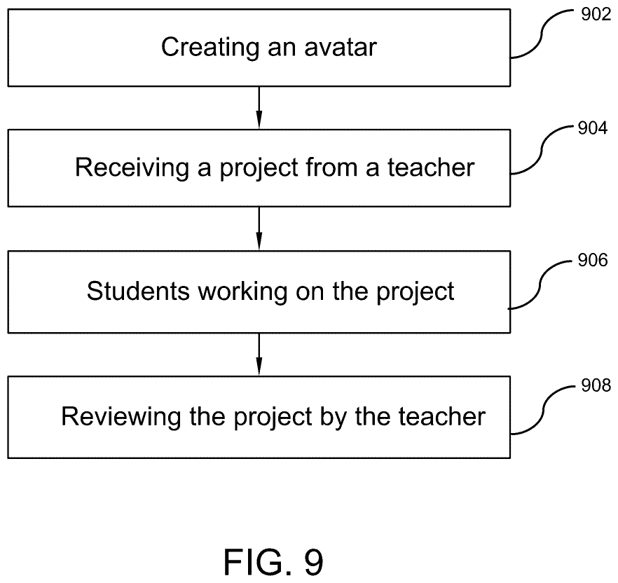

FIG. 9 illustrates a flow chart depicting a process of collaboration between the students and a teacher for reviewing performance of the students using the interactive educational system for teaching math and business concepts in accordance with the disclosed architecture. As illustrated, initially an avatar is created by a student for personalization and identification (Step 902). Then, a project depending on skill set of the student is received from a teacher by the student (Step 904). The project is preferably for building a structure and includes measuring area, perimeter of different portions of a land for making rooms, kitchen, and other structures. The project also includes profit, loss, management of money in buying furniture and more. On receiving the project, student alone or in groups start working on the project to build the structure (Step 906). Finally, the project is reviewed by the teacher and the feedback is provided to the students for their performance (Step 908).

It should be noted that as students design and construct spaces, they encounter math problems related to area, perimeter, measurement, addition, subtraction, and multiplication. Students also manage their in-game currency wisely to purchase materials and decorations, teaching budgeting skills. The application supports collaborative projects where students work together to design and build larger, more complex structures, promoting teamwork.

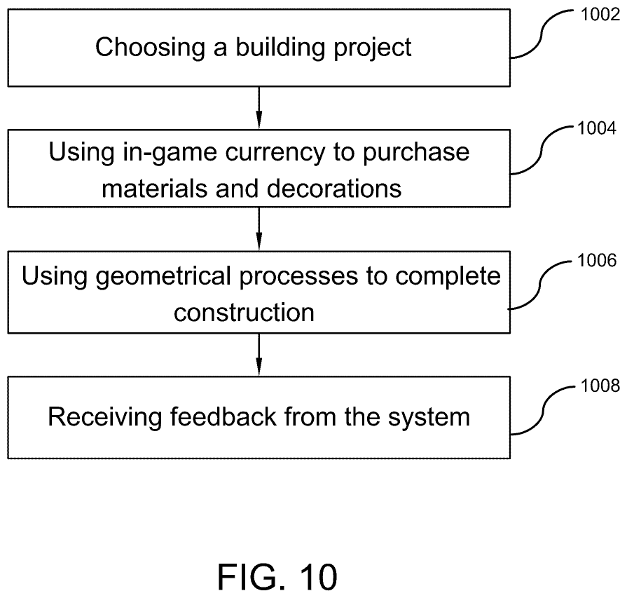

FIG. 10 illustrates another flow chart depicting a process of making structures by students while using money management and mathematical skills in accordance with one embodiment of the present invention. Initially, a student chooses a building project which can be building a structure of any shape (Step 1002). Then, using the in-game virtual currency, the student purchases materials and decorations for building the structure (Step 1004). The student builds the structure and encounters math problems related to area, perimeter, measurement, addition, subtraction, and multiplication to complete the structure (Step 1006). Finally, the student may receive the feedback and additionally can sell the structure on the marketplace (Step 1008).

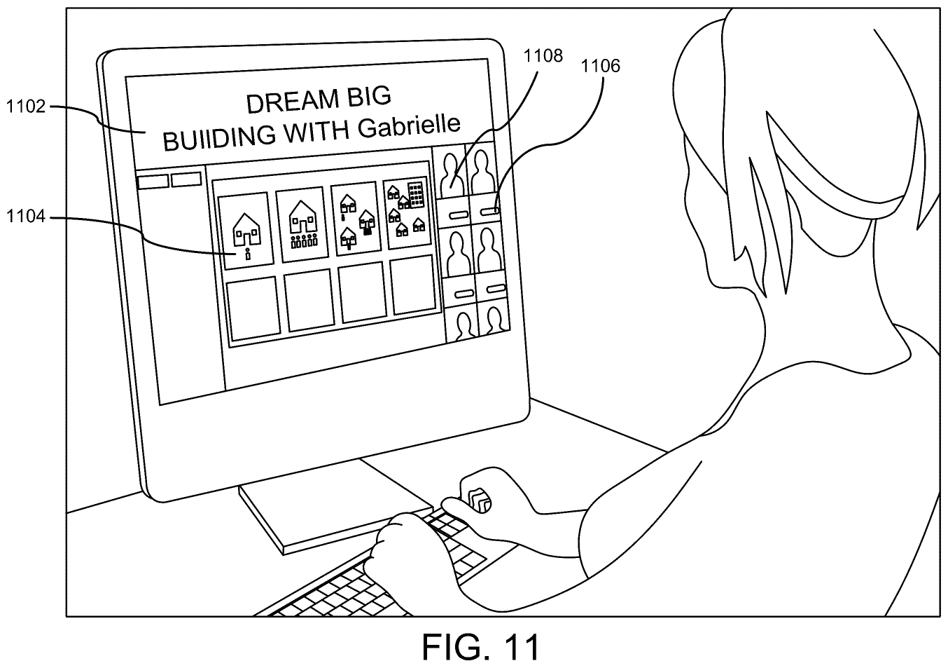

FIG. 11 illustrates a perspective view showing a teacher reviewing performance of different students based on the activities performed using the application in accordance with the disclosed architecture. As illustrated, the review interface 1102 displays different structures 1104 built by students and statistics 1106 of the students 1108. Based on the performance, the system 100 can automatically create a training plan for the individual students.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “interactive educational system for teaching math and business concepts”, “math and business concepts learning system using virtual construction and market simulation”, “math and business concepts teaching game system”, and “system” are interchangeable and refer to the math and business concepts learning system using virtual construction and market simulation 100 of the present invention.

Notwithstanding the forgoing, the math and business concepts learning system using virtual construction and market simulation 100 of the present invention can include any additional components to enhance the functionality and efficiency of the math and business concepts learning system using virtual construction and market simulation 100. One of ordinary skill in the art will appreciate that the configuration and components of the math and business concepts learning system using virtual construction and market simulation 100, as shown in the FIGS., are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interactive educational system for teaching math and business concepts, the An interactive educational system comprising:
a mobile application configured to enable users to interact with the interactive educational system for teaching math and business on a mobile device;
a web application configured to enable users to interact with the interactive educational system for teaching math and business on a web browser;
a server system comprised of a user management module configured to handle a user registration, a user profile management, and a user authentication;
a game logic service that uses artificial intelligence to customize a game based on a user profiles;
a calculation service configured to process an in-game transaction, a mathematical operation, a budget, and profit and loss calculation;
an avatar generator module enabling users to create personalized avatars; and
wherein the system is configured to simulate an entrepreneurial experience by allowing a user to engage in a building activity, including an investing and a real estate trading.

2. The interactive educational system for teaching math and business concepts of claim 1, wherein the mobile application is configured to allow interaction through a user interface that includes an option for creating a personalized avatar using a camera of a mobile device.

3. The interactive educational system for teaching math and business concepts of claim 1, wherein the web application provides an identical functionality to the mobile application, including an avatar creation and an interaction with a building project.

4. The interactive educational system for teaching math and business concepts of claim 1, wherein the user management module is configured to store a user profile in a relational database and recommend a personalized learning games based on the stored user profile.

5. The interactive educational system for teaching math and business concepts of claim 1, wherein the interactive educational system for teaching math and business uses a Node.js (Express), a Django (Python), or a Spring Boot (Java) framework to facilitate communication between the mobile application, the web application, and server system.

6. The interactive educational system for teaching math and business concepts of claim 1, wherein the user management module is further configured to authenticate a user and manage a user profile data through a secure a private communication network.

7. The interactive educational system for teaching math and business concepts of claim 1, wherein the mobile application and the web application are adapted to communicate with the server system using a RESTful API.

8. An interactive educational system for teaching math and business concepts, the An interactive educational system comprising:
a mobile application configured to enable users to interact with the interactive educational system for teaching math and business on a mobile device;
a web application configured to enable users to interact with the interactive educational system for teaching math and business on a web browser;
a marketplace module configured to allow users to sell a completed virtual structure and conduct a transaction using an in-game currency, with a profits or a loss calculated based on a sale price and a construction cost of the completed virtual structure; and
a server system comprised of:
a user management module configured to handle a user registration, an authentication, and a profile management;
a game logic service adapted to provide a user with a projects that involves constructing a virtual building and solving a math problem including an area, a perimeter, an addition, a subtraction, a multiplication, and a measurement;
a calculation service for processing an in-game transactions related to purchasing a raw material, calculating a cost, and adjusting an in-game currency balance in real-time.

9. The interactive educational system for teaching math and business concepts of claim 8, wherein the game logic service provides a user with a building project that requires a mathematical calculations such as an area, a perimeter, an addition, a subtraction, a multiplication, or a measurement calculation.

10. The interactive educational system for teaching math and business concepts of claim 8, wherein the game logic service uses an artificial intelligence to generate a customized building project based on a user profile and a user's past performance.

11. The interactive educational system for teaching math and business concepts of claim 8, wherein the calculation service is configured to process in-game transactions in real-time, including purchasing virtual raw materials and calculating profit and loss during building projects.

12. The interactive educational system for teaching math and business concepts of claim 8, wherein the calculation service processes a mathematical calculation related to a budgeting of an in-game virtual currency during a construction of a structure.

13. The interactive educational system for teaching math and business concepts of claim 8 comprising an avatar generator module that enables a user to create and customize an avatar to be used within a game, including features such as a skin tone, a hairstyle, and a face style.

14. The interactive educational system for teaching math and business concepts of claim 8, wherein the in-game currency can be used to purchase a building material and a customization item and can be earned by selling a completed virtual structure in a marketplace.

15. An interactive educational system for teaching math and business concepts, the interactive educational system comprising:
a mobile application configured to enable users to interact with the interactive educational system for teaching math and business concepts on a mobile device;
a web application configured to enable users to interact with the interactive educational system for teaching math and business concepts on a web browser; and
a server system comprised of:
a user management module for managing a user profile and a user authentication,
a game logic service for managing a game rule and customizing a gameplay based on a user profile,
a calculation service for performing a mathematical calculation and processing an in-game transactions;
a marketplace module enabling a user to sell a virtual structure created during a gameplay and to engage in a transaction using an in-game currency;
a collaborative feature allowing a first user and a second user to work together on a building project, with a progress monitored by a teacher or an educator.

16. The interactive educational system for teaching math and business concepts of claim 15, wherein the user interface allows a teacher and a parent to review an activity and a progress of a user within the system.

17. The interactive educational system for teaching math and business concepts of claim 15, wherein a user can view and modify an ongoing building project, including adding or removing a virtual furniture or a land asset during a construction of the ongoing building project.

18. The interactive educational system for teaching math and business concepts of claim 15, wherein an in-game currency balance of a user is displayed and adjusted in real-time based on a transactions performed such as a purchase or a sale in the marketplace.

19. The interactive educational system for teaching math and business concepts of claim 15, wherein a game interface displays a real-time credit rating for the user based on an available balance, a transaction history, and a number of virtual buildings sold or purchased.

20. The interactive educational system for teaching math and business concepts of claim 15 comprised of a homepage.
